(19) United States
(12) Patent Application Publication
(10) Pub. No.: US 2019/0173334 A1
(43) Pub. Date: Jun. 6, 2019

(54) ROTATING ELECTRICAL MACHINE ROTOR

(71) Applicant: DENSO CORPORATION, Kariya-city, Aichi-pref. (JP)

(72) Inventor: Yuuki TAKAHASHI, Kariya-city (JP)

(73) Assignee: DENSO CORPORATION, Kariya-city, Aichi-pref. (JP)

(21) Appl. No.: 16/314,608

(22) PCT Filed: Jun. 29, 2017
(86) PCT No.: PCT/JP2017/023854

§ 371 Date: Dec. 31, 2018

(30) Foreign Application Priority Data
Jul. 4, 2016 (JP) 2016-132791

(51) Int. Cl. H02K 1/24; H02K 19/22; H02K 1/27; H02K 1/22

(52) U.S. Cl. CPC H02K 1/243; H02K 19/22; H02K 21/044; H02K 1/226; H02K 1/276

(57) ABSTRACT

A rotating electrical machine rotor includes multiple claw-shaped magnetic pole portions, permanent magnets, and a tubular outer peripheral iron core portion. The claw-shaped magnetic pole portions face a stator in a radial direction, are arranged with clearance spaces in a circumferential direction, and are alternately magnetized to different polarities in the circumferential direction by power application to a field winding. A permanent magnet is arranged in each clearance space such that the polarity of each of side surfaces facing the claw-shaped magnetic pole portions in the circumferential direction is the same as the polarity of a corresponding one of the claw-shaped magnetic pole portions. An outer peripheral iron core portion covers an outer peripheral side of the claw-shaped magnetic pole portions. The outer peripheral iron core portion has a tubular body portion and magnet holding portions configured to hold the permanent magnets.

### TECHNICAL FIELD

The present disclosure relates to a rotating electrical machine rotor used for a rotating electrical machine.

### BACKGROUND ART

Typically, a rotating electrical machine used for, e.g., an electric motor or a power generator of a vehicle and including a stator and a rotor has been known (e.g., Patent Literature 1 and 2). The rotor of such a rotating electrical machine has multiple magnetic pole portions arranged with clearances in a circumferential direction. The magnetic pole portions protrude in a claw shape from an outer peripheral edge portion of an axial end of a rotor core along an axial direction. The magnetic pole portions are alternately magnetized to different polarities (specifically the N-pole and the S-pole) in the circumferential direction by power application to an annular field winding wound around an axial center portion. When each magnetic pole portion is magnetized, rotation of the rotor of the rotating electrical machine is controlled.

As described in Patent Literature 1, the rotor of the rotating electrical machine has, in some cases, a permanent magnet (i.e., an inter-pole magnet) arranged between each two adjacent magnetic pole portions in the circumferential direction. This permanent magnet is magnetized such that the polarity of a side surface facing the magnetic pole portion in the circumferential direction is the same as the polarity of the magnetic pole portion. Moreover, the permanent magnet has the function of enhancing a magnetic flux between the magnetic pole portion of the rotor and a stator core of the stator.

As described in Patent Literature 2, the rotor of the rotating electrical machine has, in some cases, a cylindrical outer peripheral iron core portion covering the outer periphery of the magnetic pole portions. Such a rotor provided with the outer peripheral iron core portion has a smooth outer peripheral surface of the rotor. Thus, wind noise due to irregularity of the outer peripheral surface can be reduced. Moreover, in the rotor, the multiple magnetic pole portions adjacent to each other in the circumferential direction are coupled by the outer peripheral iron core portion. Thus, in, e.g., the structure in which the permanent magnet is arranged between the magnetic pole portions as described in Patent Literature 1, an increase in deformation of the magnetic pole portion in a radial direction due to centrifugal force of the permanent magnet upon rotation of the rotor can be suppressed.

As described in Patent Literature 1, the rotor of the rotating electrical machine has, in some cases, a magnet holding portion configured to hold the permanent magnet. The magnet holding portion holds the permanent magnet between adjacent ones of the magnetic pole portions in the circumferential direction, and exhibits elasticity acting in a rotation direction of the rotor. The magnet holding portion is provided separately from the outer peripheral iron core portion. Moreover, the magnet holding portion is inserted between the magnetic pole portions with the permanent magnet being housed in the magnet holding portion, and thereafter, is pressed against the magnetic pole portions by elastic force. In this manner, the magnet holding portion holds the permanent magnet between the magnetic pole portions.

### CITATION LIST

### Patent Literature

[PTL 1]: JP 2010-16958 A

[PTL 2]: JP 2009-148057 A

### SUMMARY OF THE INVENTION

### Technical Problem

The above-described magnet holding portion includes a magnet holding portion formed from a non-magnetic body such as stainless steel. However, in a case where the magnet holding portion is formed from the non-magnetic body, magnetic resistance of a magnetic circuit passing through the permanent magnet held by the magnet holding portion is increased. In a case where it is configured such that the magnet holding portion uses the elastic force to hold the permanent magnet between the magnetic pole portions as described above, a gap might be formed between the magnet holding portion and the magnetic pole portion. Due to the presence of such a gap, the magnetic resistance of the magnetic circuit passing through the permanent magnet is also increased.

The present disclosure provides a rotating electrical machine rotor capable of holding a permanent magnet between magnetic pole portions using a magnet holding portion and increasing permeance of a magnetic circuit passing through the permanent magnet.

### Solution to Problem

A first rotating electrical machine rotor as one aspect of the technique of the present disclosure includes multiple magnetic pole portions facing a stator in a radial direction, arranged with clearance spaces therebetween in a circumferential direction, and alternately magnetized to different polarities in the circumferential direction by power application to a field winding, permanent magnets arranged in each clearance space such that the polarity of each of side surfaces facing the magnetic pole portions in the circumferential direction is the same as the polarity of a corresponding one of the magnetic pole portions; and a tubular outer peripheral iron core portion configured to cover an outer peripheral side of the magnetic pole portions. The outer peripheral iron core portion has a tubular body portion and magnet holding portions configured to hold the permanent magnet.

According to this configuration, the first rotating electrical machine rotor can hold the permanent magnet between the magnetic pole portions using the magnet holding portion of the outer peripheral iron core portion. Moreover, the magnet holding portion is an iron core arranged along a surface of the permanent magnet, and closely contacts the permanent magnet. Thus, the first rotating electrical machine rotor can decrease magnetic resistance of a magnetic circuit passing through the permanent magnet as compared to a structure in which a magnet holding portion is formed from a non-magnetic body or a structure in which a large gap is formed between a permanent magnet and a magnetic pole portion. Thus, the first rotating electrical machine rotor holds the permanent magnet between the magnetic pole portions using the magnet holding portion while increasing permeance of the magnetic circuit passing through the permanent magnet.

In the first rotating electrical machine rotor, the magnet holding portion is formed to protrude radially inward from an inner peripheral surface of the tubular body portion while gripping the permanent magnet.

According to this configuration, the first rotating electrical machine rotor can sandwich and hold the permanent magnet between the magnetic pole portions using the magnet holding portion protruding from the inner peripheral surface of the tubular body portion of the outer peripheral iron core portion toward the radial inside.

In the first rotating electrical machine rotor, the outer peripheral iron core portion has a structure in which soft magnetic thin plate members are stacked on each other in an axial direction or a structure in which a soft magnetic linear member or a band-shaped member is spirally stacked in the axial direction. The outer peripheral iron core portion is integrated such that the thin plate members or stacked portions of the linear member or the band-shaped member are bonded along the axial direction using the magnet holding portion.

According to this configuration, in the first rotating electrical machine rotor, the thin plate members or the stacked portions of the linear member or the band-shaped member are not bonded on an outer peripheral side of the outer peripheral iron core portion. With this configuration, the first rotating electrical machine rotor causes less disturbance in a magnetic flux flow due to a skin effect, and can ensure favorable magnetic properties. Moreover, the magnet holding portion as a thick portion of the outer peripheral iron core portion is present at a portion on which stress due to centrifugal force in association with rotation of a rotating electrical machine is concentrated. In this manner, the strength of the rotor is reinforced.

In the first rotating electrical machine rotor, the tubular body portion and the magnet holding portion are formed from different components.

According to this configuration, the first rotating electrical machine rotor can reduce waste material upon formation of the outer peripheral iron core portion, and can improve the yield rate when producing the outer peripheral iron core portion. Moreover, a material of the magnet holding portion and a material of the tubular body portion can be changed as necessary.

In the first rotating electrical machine rotor, the magnet holding portion has a side surface holding portion facing a corresponding surface of the permanent magnet and extending along the axial direction. According to this configuration, the first rotating electrical machine rotor can hold the permanent magnet in the circumferential direction using the side surface holding portion.

In the first rotating electrical machine rotor, the magnetic pole portions include first and second magnetic pole portions formed such that a circumferential width changes from a base side in the axial direction to a tip end side in the axial direction, alternately arranged in the circumferential direction such that the position of the base side in the axial direction and the position of the tip end side in the axial direction are on opposite sides in the axial direction, and magnetized to different polarities. The clearance spaces include first and second clearance spaces inclined from a first side to a second side in the axial direction at a predetermined angle with respect to a rotation axis and provided in different skew directions inclined with respect to the rotation axis. The outer peripheral iron core portion has a structure in which cylindrical first and second divided iron core portions divided in half in the axial direction are bonded at a center position in the axial direction. The first divided iron core portion has the side surface holding portion for holding a first permanent magnet arranged in the first clearance space. The second divided iron core portion has the side surface holding portion for holding a second permanent magnet arranged in the second clearance space.

According to this configuration, the first rotating electrical machine rotor holds each of the permanent magnets arranged in the first and second clearance spaces different from each other in the skew direction inclined with respect to the rotation axis by the side surface holding portions of the divided iron core portions as separated bodies divided in half in the axial direction.

In the first rotating electrical machine rotor, the first divided iron core portion is formed such that the side surface holding portion holds the permanent magnet in a state in which the first divided iron core portion is inserted onto each magnetic pole portion while rotating in a first spiral direction corresponding to the skew direction of the first clearance space. The second divided iron core portion is formed such that the side surface holding portion holds the permanent magnet in a state in which the second divided iron core portion is inserted onto each magnetic pole portion while rotating in a second spiral direction corresponding to the skew direction of the second clearance space.

According to this configuration, in the first rotating electrical machine rotor, each of the first and second divided iron core portions divided in half in the axial direction can be inserted onto the magnetic pole portions while rotating in the spiral direction corresponding to the skew direction of the clearance space, and both of the divided iron core portions can be bonded at the center position in the axial direction. Moreover, the first rotating electrical machine rotor can implement the anti-rotation function of preventing the magnetic pole portions from rotating in the circumferential direction relative to the outer peripheral iron core portion including the first divided iron core portion and the second divided iron core portion after bonding of both of the divided iron core portions.

In the first rotating electrical machine rotor, the magnet holding portion has an axial end surface holding portion facing an axial end surface of the permanent magnet and extending along the circumferential direction. According to this configuration, the first rotating electrical machine rotor can hold the permanent magnet in the axial direction using the axial end surface holding portion.

In the first rotating electrical machine rotor, the magnet holding portion is formed with a tapered section to divide a space between the permanent magnet and the tubular body portion into an internal space where the permanent magnet is held and a predetermined space formed on the outside of the internal space in the radial direction. Each magnetic pole portion has a tapered portion arranged to fill the predetermined space.

According to this configuration, in the first rotating electrical machine rotor, stress on the permanent magnet due to centrifugal force generated in association with rotation of the rotating electrical machine is provided not only to the outer peripheral iron core portion but also to the tapered portion of each magnetic pole portion. Thus, the stress on the permanent magnet due to the centrifugal force is dispersed to the outer peripheral iron core portion and the magnetic pole portions. In this manner, the strength of the rotor is improved. Alternatively, the width of the tubular body portion of the outer peripheral iron core portion in the radial direction can be decreased within a range where predetermined strength is ensured.

In the first rotating electrical machine rotor, the permanent magnet is divided into two or more magnets in the circumferential direction at a q-axis at a position shifted from a d-axis passing through the center of each magnetic pole portion in the circumferential direction by an electrical angle of 90°. The magnet holding portion is formed to hold the permanent magnet, surround each magnetic pole portion, and have an iron core portion at which a q-axis magnetic circuit passing through the q-axis is formed.

According to this configuration, the first rotating electrical machine rotor can hold, between the magnetic pole portions, the permanent magnets divided in the circumferential direction. Moreover, a q-axis magnetic circuit magnetically isolated from a d-axis magnetic circuit can be formed on the q-axis by means of the magnet holding portion. Thus, reluctance torque is generated to improve torque.

### BRIEF DESCRIPTION OF THE DRAWINGS

FIG. 1 is a sectional view of a rotating electrical machine including a rotating electrical machine rotor according to a first embodiment.

FIG. 2 is a view when the rotating electrical machine rotor of the first embodiment is viewed from the outside in a radial direction.

FIG. 3 is a perspective view of the rotating electrical machine rotor of the first embodiment.

FIG. 4 is a perspective view of the rotating electrical machine rotor of the first embodiment excluding an outer peripheral iron core portion.

FIG. 5 is a perspective view of part of the rotating electrical machine rotor of the first embodiment.

FIG. 6 is a perspective view of part of claw-shaped magnetic pole portions of the outer peripheral iron core portion included in the rotating electrical machine rotor of the first embodiment.

FIG. 7 is a perspective view of part of permanent magnets of one divided iron core portion of the outer peripheral iron core portion included in the rotating electrical machine rotor of the first embodiment.

FIG. 8 is a sectional view of a main portion of the rotating electrical machine rotor of the first embodiment.

FIG. 9 is a plan view of part of thin plate members forming the outer peripheral iron core portion included in the rotating electrical machine rotor of the first embodiment.

FIG. 10 is a perspective view of a linear member forming an outer peripheral iron core portion included in a rotating electrical machine rotor according to a variation.

FIG. 11 is a perspective view of a band-shaped member forming an outer peripheral iron core portion included in a rotating electrical machine rotor according to a variation.

FIG. 12 is a perspective view of a main portion of an outer peripheral iron core portion included in a rotating electrical machine rotor according to a variation.

FIG. 13 is a sectional view of a main portion of the rotating electrical machine rotor illustrated in FIG. 12.

FIG. 14 is a view for describing a phenomenon caused in a case where a magnetic holding portion and a tubular body portion included in an outer peripheral iron core portion of a rotating electrical machine rotor are formed from a single component.

FIG. 15 is a sectional view of a main portion of a rotating electrical machine rotor according to a variation.

FIG. 16 is a perspective view of part of a rotating electrical machine rotor of a variation.

FIG. 17 is a perspective view of the rotating electrical machine rotor illustrated in FIG. 16 with no claw-shaped magnetic pole portions being illustrated.

FIG. 18 is a sectional view of a main portion of a rotating electrical machine rotor according to a variation.

FIG. 19 is a sectional view of a main portion of a rotating electrical machine rotor according to a variation.

FIG. 20 is a sectional view of a main portion of a rotating electrical machine rotor according to a variation.

### DESCRIPTION OF EMBODIMENTS

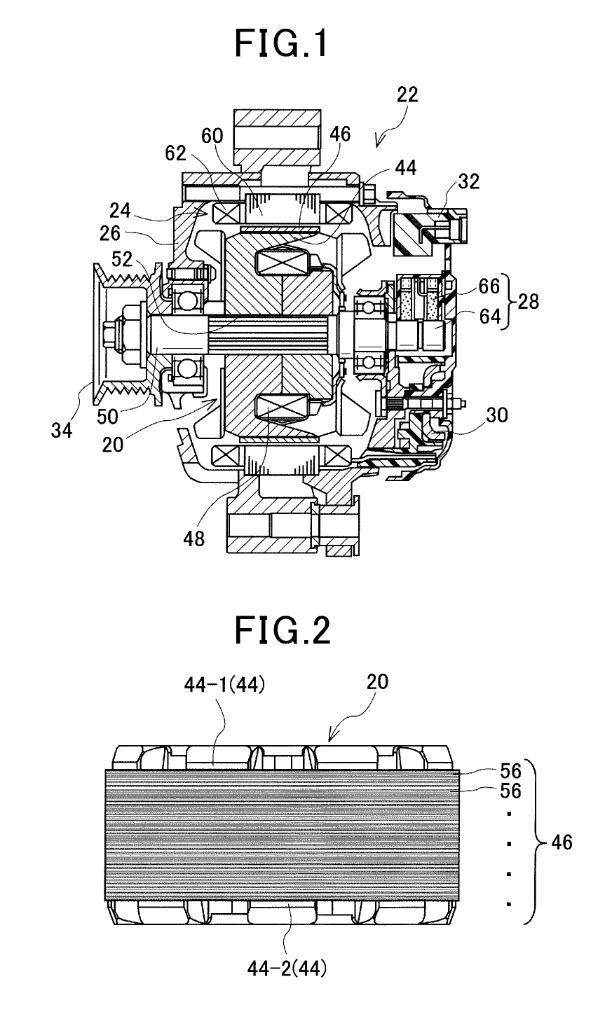

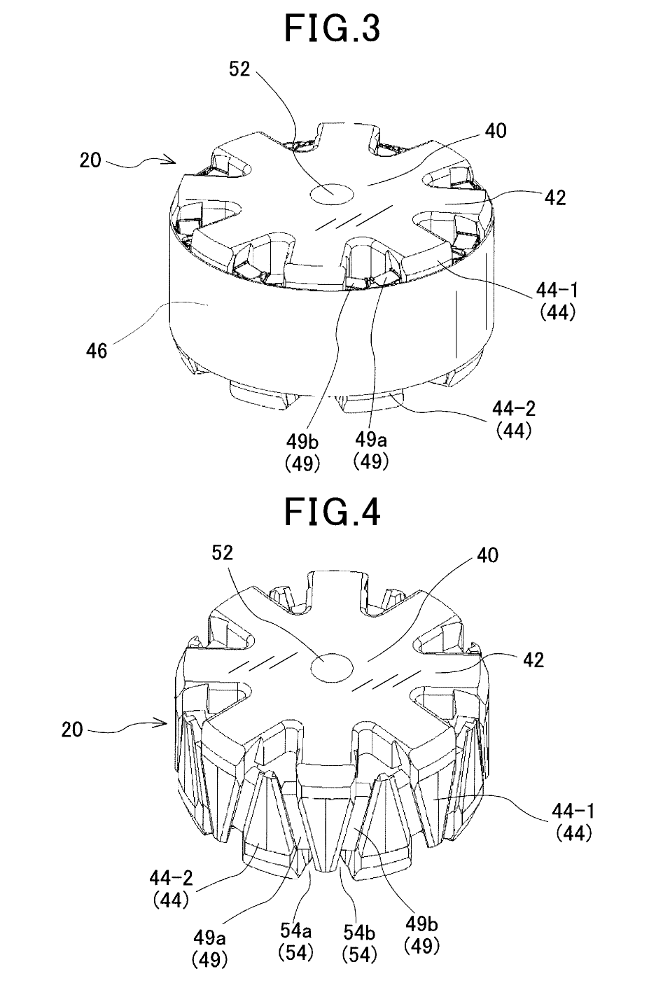

Hereinafter, a specific embodiment of a rotating electrical machine rotor as one aspect of the technique of the present disclosure will be described with reference to the drawings. First, a configuration of a rotating electrical machine including a rotor according to a first embodiment will be described with reference to FIGS. 1 to 9.

### First Embodiment

In the present embodiment, a rotating electrical machine rotor 20 is, as illustrated in FIG. 1 by way of example, a rotor provided at a rotating electrical machine 22 mounted on, e.g., a vehicle. Hereinafter, the rotating electrical machine rotor 20 will be simply referred to as a “rotor 20.” The rotating electrical machine 22 is configured to receive power supplied from a power source such as a battery, thereby generating drive force for driving the vehicle. Moreover, the rotating electrical machine 22 is configured to receive drive force supplied from an engine of the vehicle, thereby generating power for charging the battery. The rotating electrical machine 22 includes the rotor 20, a stator 24, a housing 26, a brush device 28, a rectification device 30, a voltage adjuster 32, and a pulley 34.

As illustrated in FIGS. 1, 2, 3, and 4 by way of example, the rotor 20 includes a boss portion 40, a disc portion 42, claw-shaped magnetic pole portions 44, an outer peripheral iron core portion 46, a field winding 48, and permanent magnets 49. The rotor 20 is a Lundell type rotor. The boss portion 40 is a tubular member having a shaft hole 52 opening on a center axis so that a rotary shaft 50 can be inserted into the shaft hole 52. The boss portion 40 is a portion to be fitted and fixed on an outer peripheral side of the rotary shaft 50. The disc portion 42 is a discoid portion extending from an end surface side of the boss portion 40 in an axial direction toward the outside in a radial direction.

The claw-shaped magnetic pole portions 44 are continuously connected to an outer peripheral end of the disc portion 42. The claw-shaped magnetic pole portion 44 is a member protruding in a claw shape from such a connection portion along the axial direction. The claw-shaped magnetic pole portions 44 are arranged on the outside of the boss portion 40 in the radial direction. The boss portion 40, the disc portion 42, and the claw-shaped magnetic pole portions 44 form a pole core (a field core). The pole core is, e.g., molded by hammering. The claw-shaped magnetic pole portion 44 has an outer peripheral surface formed in an arc shape. The outer peripheral surface of the claw-shaped magnetic pole portion 44 has an arc about the vicinity of the axial center of the rotary shaft 50. Specifically, the outer peripheral surface of the claw-shaped magnetic pole portion 44 has an arc about the axial center of the rotary shaft 50 or an arc about a position closer to the claw-shaped magnetic pole portion 44 with respect to the axial center.

The claw-shaped magnetic pole portions 44 include first claw-shaped magnetic pole portions 44-1 and second claw-shaped magnetic pole portions 44-2, the first claw-shaped magnetic pole portion 44-1 and the second claw-shaped magnetic pole portion 44-2 being magnetized to different polarities (the N-pole and the S-pole). The first claw-shaped magnetic pole portion 44-1 and the second claw-shaped magnetic pole portion 44-2 form a pair of pole cores. The same number (e.g., eight) of first claw-shaped magnetic pole portions 44-1 and the same number of second claw-shaped magnetic pole portions 44-2 are provided about the axis of the rotary shaft 50. The first claw-shaped magnetic pole portions 44-1 and the second claw-shaped magnetic pole portions 44-2 are alternately arranged with clearance spaces 54 in a circumferential direction.

The first claw-shaped magnetic pole portions 44-1 are continuously connected to the outer peripheral end of the disc portion 42 extending from a first end side of the boss portion 40 in the axial direction to the radial outside. Moreover, the first claw-shaped magnetic pole portions 44-1 protrude toward a second end side in the axial direction. The second claw-shaped magnetic pole portions 44-2 are continuously connected to the outer peripheral end of the disc portion 42 extending from the second end side of the boss portion 40 in the axial direction to the radial outside. Moreover, the second claw-shaped magnetic pole portions 44-2 protrude toward the first end side in the axial direction. The first claw-shaped magnetic pole portion 44-1 and the second claw-shaped magnetic pole portion 44-2 are formed in a common shape, except for an arrangement position and a protruding direction in the axial direction. The first claw-shaped magnetic pole portions 44-1 and the second claw-shaped magnetic pole portions 44-2 are alternately arranged in the circumferential direction such that a base side in the axial direction and a tip end side in the axial direction are on opposite sides in the axial direction. Moreover, the first claw-shaped magnetic pole portion 44-1 and the second claw-shaped magnetic pole portion 44-2 are magnetized to different polarities.

Each of the claw-shaped magnetic pole portions 44 including the first claw-shaped magnetic pole portions 44-1 and the second claw-shaped magnetic pole portions 44-2 is formed with a predetermined width (a circumferential width) in the circumferential direction and a predetermined thickness (a radial thickness) in the radial direction. Each claw-shaped magnetic pole portion 44 is formed such that the circumferential width gradually decreases and the radial thickness gradually decreases from the base side near the portion continuously connected to the disc portion 42 toward the tip end side in the axial direction. That is, each claw-shaped magnetic pole portion 44 is, in both of the circumferential direction and the radial direction, formed narrower toward the tip end side in the axial direction. Each claw-shaped magnetic pole portion 44 is preferably formed symmetrically in the circumferential direction with respect to the center in the circumferential direction.

Each of the above-described clearance spaces 54 is provided between the first claw-shaped magnetic pole portion 44-1 and the second claw-shaped magnetic pole portion 44-2 adjacent to each other in the circumferential direction. The clearance space 54 extends diagonally in the axial direction. Moreover, the clearance space 54 is inclined from a first side to a second side in the axial direction at a predetermined angle with respect to a rotation axis of the rotor 20. All clearance spaces 54 have the same shape. Each clearance space 54 is set such that a size (a dimension) in the circumferential direction little changes according to a position in the axial direction. That is, it is set such that the dimension of each clearance space 54 in the circumferential direction is maintained constant or is maintained within a slight range including such a constant value. That is, the first claw-shaped magnetic pole portions 44-1 and the second claw-shaped magnetic pole portions 44-2 are arranged such that the clearance spaces 54 have a constant circumferential dimension at any position in the axial direction and all clearance spaces 54 in the circumferential direction have the same shape.

In the rotor 20, all clearance spaces 54 in the circumferential direction preferably have the same shape for avoiding magnetic unbalance. However, particularly in the rotor 20 configured to rotate only in one direction, the shape of the claw-shaped magnetic pole portion 44 may be, for, e.g., reduction in iron loss, a shape asymmetrical in the circumferential direction with respect to the center in the circumferential direction, and the dimension of the clearance space 54 in the circumferential direction is not necessarily constant according to the position in the axial direction.

The outer peripheral iron core portion 46 is arranged on an outer peripheral side of the claw-shaped magnetic pole portions 44 (the first claw-shaped magnetic pole portions 44-1 and the second claw-shaped magnetic pole portions 44-2). The outer peripheral iron core portion 46 is a cylindrical or circular ring-shaped member covering the outer periphery of the claw-shaped magnetic pole portions 44. The outer peripheral iron core portion 46 is a thin plate member having a predetermined thickness (e.g., about 0.6 [mm] to 1.0 [mm] realizing both of the mechanical strength and magnetic performance of the rotor 20) in the radial direction. The outer peripheral iron core portion 46 contacts the claw-shaped magnetic pole portions 44 with the outer peripheral iron core portion 46 facing the outer peripheral side of the claw-shaped magnetic pole portions 44. Moreover, the outer peripheral iron core portion 46 closes the clearance spaces 54 on the outside of the clearance spaces 54 in the radial direction, and couples the claw-shaped magnetic pole portions 44 adjacent to each other in the circumferential direction.

The outer peripheral iron core portion 46 is made of a soft magnetic material such as a magnetic steel sheet made of, e.g., iron or silicon steel. As illustrated in FIG. 2 by way of example, the outer peripheral iron core portion 46 has such a structure that multiple soft magnetic thin plate members (e.g., magnetic steel sheets) 56 are stacked on each other in the axial direction. The thin plate member 56 is a punched-out member punched out in a desired shape by means of a die. Each thin plate member 56 has a predetermined thickness in the radial direction, and has a predetermined width in a stacking direction. For reducing eddy-current loss, each thin plate member 56 is interlayer-insulated from adjacent thin plate members 56 in the axial direction. The outer peripheral iron core portion 46 is fixed to the claw-shaped magnetic pole portions 44 by shrink fitting, pressure fitting, welding, or a combination thereof.

The outer peripheral iron core portion 46 has the function of smoothing an outer peripheral surface of the rotor 20 to reduce wind noise due to irregularity of the outer peripheral surface of the rotor 20. Moreover, the outer peripheral iron core portion 46 has the function of coupling the multiple claw-shaped magnetic pole portions 44 arranged in the circumferential direction to reduce deformation (particularly deformation in the radial direction) of each claw-shaped magnetic pole portion 44.

The field winding 48 is arranged in a clearance between the boss portion 40 and each claw-shaped magnetic pole portion 44. The field winding 48 is a coil member configured to generate a magnetic flux by distribution of DC current. The field winding 48 is wound about the axis on an outer peripheral side of the boss portion 40. The magnetic flux generated by the field winding 48 is guided to the claw-shaped magnetic pole portions 44 via the boss portion 40 and the disc portion 42. That is, the boss portion 40 and the disc portion 42 form a magnetic path portion for guiding the magnetic flux generated at the field winding 48 to the claw-shaped magnetic pole portions 44. The field winding 48 has the function of magnetizing, by the generated magnetic flux, the first claw-shaped magnetic pole portions 44-1 to the N-pole and magnetizing the second claw-shaped magnetic pole portions 44-2 to the S-pole.

The permanent magnets 49 are housed on an inner peripheral side of the outer peripheral iron core portion 46. The permanent magnet 49 is an inter-pole magnet arranged to fill the clearance space 54 between adjacent ones of the claw-shaped magnetic pole portions 44 in the circumferential direction (between the first claw-shaped magnetic pole portion 44-1 and the second claw-shaped magnetic pole portion 44-2). The permanent magnets 49 are each arranged in the clearance spaces 54, and the same number of permanent magnets 49 as that of the clearance spaces 54 is provided. Each permanent magnet 49 extends along the shape of the clearance space 54, inclined diagonally with respect to the rotation axis of the rotor 20. Moreover, each permanent magnet 49 is formed in a substantially rectangular parallelepiped shape. The permanent magnets 49 are held with a holder described in detail later. The permanent magnet 49 has the function of reducing magnetic flux leakage between the claw-shaped magnetic pole portions 44 of the rotor 20 and enhancing a magnetic flux between the claw-shaped magnetic pole portion 44 and a stator iron core of the stator 24.

The permanent magnet 49 is arranged such that a magnetic pole in the direction of decreasing magnetic flux leakage between the claw-shaped magnetic pole portions 44 adjacent in the circumferential direction is formed. Specifically, the permanent magnet 49 is configured such that its N magnetic pole faces towards the N-pole of the first claw-shaped magnetic pole portion 44-1. Moreover, the permanent magnet 49 is configured such that its S magnetic pole faces towards the S-pole of the first claw-shaped magnetic pole portion 44-2. The permanent magnet 49 is configured as described above. The permanent magnet 49 is magnetized such that magnetomotive force is in the circumferential direction. Note that the present embodiment may be applied to a configuration in which the permanent magnets 49 are mounted in the rotor 20 after having been magnetized. Note that the present embodiment is preferably applied to a configuration in which the permanent magnets 49 are magnetized after having been mounted in the rotor 20.

In description below, the clearance space 54 will be sometimes described as two divided spaces (first and second clearance spaces). Specifically, a clearance when the first claw-shaped magnetic pole portion 44-1 is present on a first side in the circumferential direction (on a leftward rotation side as a counterclockwise side in FIG. 4) and the second claw-shaped magnetic pole portion 44-2 is present on a second side in the circumferential direction (on a rightward rotation side as a clockwise side in FIG. 4) will be referred to as a “first clearance space 54a.” Moreover, a clearance when the first claw-shaped magnetic pole portion 44-1 is present on the second side in the circumferential direction and the second claw-shaped magnetic pole portion 44-2 is present on the first side in the circumferential direction will be referred to as a “second clearance space 54b.”

The first clearance space 54a and the second clearance space 54b are provided such that a skew direction inclined with respect to the rotation axis of the rotor 20 is different between a counterclockwise spiral direction and a clockwise spiral direction. The first clearance space 54a is skewed away from the counterclockwise spiral direction with respect to the rotation axis. Moreover, the second clearance space 54b is skewed away from the clockwise spiral direction with respect to the rotation axis. Preferably, an absolute value of the angle of the first clearance space 54a with respect to the rotation axis in the skew direction and an absolute value of the angle of the second clearance space 54b with respect to the rotation axis in the skew direction are substantially same as each other. Note that the “counterclockwise spiral direction” indicates that a direction from a near side to a far side is counterclockwise. Moreover, the “clockwise spiral direction” indicates that the direction from the near side to the far side is clockwise.

In description below, the permanent magnet 49 will be sometimes described as two divided magnets (first and second permanent magnets). Specifically, a magnet arranged in the first clearance space 54a such that a side surface 58n whose magnetic pole is the N-pole faces a first side in the circumferential direction (on the leftward rotation side as the counterclockwise side in FIG. 4) and a side surface 58s whose magnetic pole is the S-pole faces a second side in the circumferential direction (on the rightward side as the clockwise side in FIG. 4) will be referred to as a “first permanent magnet 49a.” Moreover, a magnet arranged in the second clearance space 54b such that a side surface 58n whose magnetic pole is the N-pole faces the second side in the circumferential direction and a side surface 58s whose magnetic pole is the S-pole faces the first side in the circumferential direction will be referred to as a “second permanent magnet 49b.” As illustrated in FIGS. 4, 5, and 7 by way of example, the first permanent magnet 49a is arranged to extend in the counterclockwise spiral direction with respect to the rotation axis. Moreover, as illustrated in FIG. 4 by way of example, the second permanent magnet 49b is arranged to extend in the clockwise spiral direction with respect to the rotation axis.

The stator 24 has a stator iron core 60 and a stator winding 62. The stator iron core 60 is a member formed in a cylindrical shape. The stator iron core 60 is arranged facing the rotor 20 with a predetermined air gap on the radial outside. The stator winding 62 is a coil member wound around teeth of the stator iron core 60 such that each straight portion is housed in a slot formed at the stator iron core 60. The stator winding 62 corresponds to multiple phases (e.g., three phases).

The stator 24 forms part of a magnetic path. The stator 24 is a member configured to receive a rotating magnetic field provided by rotation of the rotor 20, thereby generating electromotive force. The rotor 20 forms part of the magnetic path. The rotor 20 is a member configured to form a magnetic pole by a current flow.

The housing 26 is a case member configured to house the stator 24 and the rotor 20. The housing 26 supports the rotor 20 such that the rotor 20 is rotatable about the axis of the rotary shaft 50. Moreover, the housing 26 fixes the stator 24.

The brush device 28 has a slip ring 64 and brushes 66. The slip ring 64 is fixed to a first end of the rotary shaft 50 in the axial direction. The slip ring 64 has the function of supplying current to the field winding 48 of the rotor 20. Two brushes 66 are provided in a pair. Moreover, the brushes 66 are held by a brush holder attached to the housing 26 in a fixed manner. The brushes 66 are arranged while being pressed toward the rotary shaft 50 such that inner tip ends of the brushes 66 in the radial direction slide on a surface of the slip ring 64. The brushes 66 are configured to apply current to the field winding 48 via the slip ring 64.

The rectification device 30 is electrically connected to the stator winding 62 of the stator 24. The rectification device 30 is a device configured to rectify AC generated by the stator winding 62 into DC, thereby outputting the DC. The voltage adjuster 32 is configured to control field current flowing in the field winding 48, thereby adjusting the output voltage of the rotating electrical machine 22. The voltage adjuster 32 has the function of maintaining the output voltage substantially constant, the output voltage being changeable according to an electric load or a power generation amount. The pulley 34 is configured to transmit rotation of the vehicle engine to the rotor 20 of the rotating electrical machine 22. The pulley 34 is fastened and fixed to a second end of the rotary shaft 50 in the axial direction.

In the rotating electrical machine 22 having such a structure, DC current is supplied from the power source to the field winding 48 of the rotor 20 via the brush device 28. Then, in the rotating electrical machine 22, such current generates a magnetic flux circulating in the boss portion 40, the disc portion 42, and the claw-shaped magnetic pole portions 44 through the field winding 48. This magnetic flux forms, for example, a magnetic circuit for a flow in the order of the boss portion 40 of one pole core, the disc portion 42, the first claw-shaped magnetic pole portions 44-1, the stator iron core 60, the second claw-shaped magnetic pole portions 44-2, the disc portion 42 of the other pole core, the boss portion 40, and the boss portion 40 of one pole core. This magnetic circuit generates back electromotive force of the rotor 20.

The above-described magnetic flux is guided to the first claw-shaped magnetic pole portions 44-1 and the second claw-shaped magnetic pole portions 44-2. As a result, the first claw-shaped magnetic pole portions 44-1 are magnetized to the N-pole. Moreover, the second claw-shaped magnetic pole portions 44-2 are magnetized to the S-pole. In a state in which such magnetization of the claw-shaped magnetic pole portions 44 is performed, DC current supplied from the power source is converted into, e.g., three-phase AC, and then, the three-phase AC is supplied to the stator winding 62. In this manner, the rotor 20 rotates relative to the stator 24. Thus, in the configuration according to the present embodiment, the rotating electrical machine 22 can function as an electric motor to be rotatably driven by a power supply to the stator winding 62.

The rotor 20 of the rotating electrical machine 22 is rotated in such a manner that rotation torque of the vehicle engine is transmitted to the rotary shaft 50 via the pulley 34. Rotation of the rotor 20 provides the rotating magnetic field to the stator winding 62 of the stator 24, thereby generating AC electromotive force at the stator winding 62. The AC electromotive force generated at the stator winding 62 is rectified into DC through the rectification device 30, and thereafter, the DC is supplied to the battery. Thus, in the configuration according to the present embodiment, the rotating electrical machine 22 can function as a power generator configured to charge the battery by generation of the electromotive force of the stator winding 62.

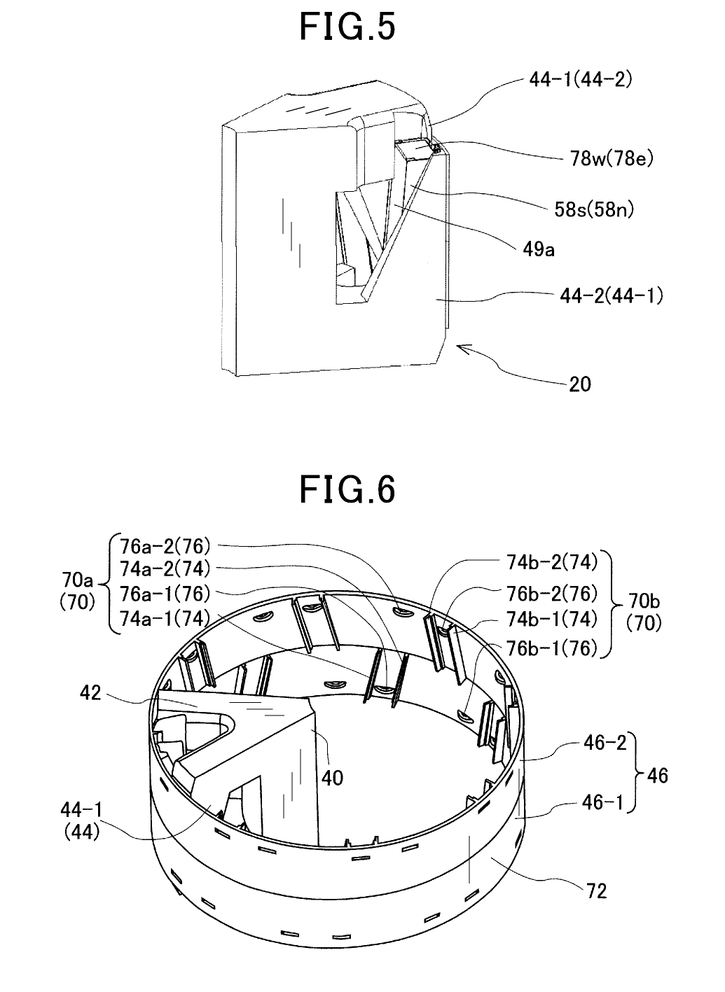

Next, characteristic portions of the rotor 20 of the present embodiment will be described with reference to FIGS. 5 to 9.

In the present embodiment, the rotor 20 includes the tubular outer peripheral iron core portion 46 covering the radial outside, i.e., the outer peripheral side of the claw-shaped magnetic pole portions 44. The permanent magnet 49 is arranged between adjacent ones of the claw-shaped magnetic pole portions 44 (in the clearance space 54). Moreover, the permanent magnets 49 are each held by magnet holding portions 70. As illustrated in FIG. 6 by way of example, the magnet holding portions 70 are provided integrally with the outer peripheral iron core portion 46. The magnet holding portions 70 are made of the same soft magnetic material as that of a tubular body portion 72 of the outer peripheral iron core portion 46. That is, the outer peripheral iron core portion 46 has the magnet holding portions 70 as the holder for holding the permanent magnets 49.

The magnet holding portion 70 is a portion molded integrally with the tubular body portion 72 of the outer peripheral iron core portion 46. The magnet holding portion 70 is provided integrally with an inner peripheral surface of the tubular body portion 72. The magnet holding portion 70 is a raised portion formed to hold the permanent magnet 49 while protruding from the inner peripheral surface of the tubular body portion 72 toward the radial inside (toward the axial center). The magnet holding portions 70 are, in a one-on-one manner, provided corresponding to all permanent magnets 49 included in the rotor 20. The magnet holding portions 70 include first magnet holding portions 70a each configured to hold the first permanent magnets 49a, and second magnet holding portions 70b each configured to hold the second permanent magnets 49b.

The magnet holding portion 70 is arranged on four sides (both sides in the circumferential direction and both sides in the axial direction) of the substantially rectangular parallelepiped permanent magnet 49 inserted into the clearance space 54. The magnet holding portion 70 has, for each permanent magnet 49, a pair of side surface holding portions 74 forming walls facing the circumferential direction, and a pair of axial end surface holding portions 76 forming walls facing the axial direction. The first magnet holding portions 70a are each provided corresponding to the first permanent magnets 49a. Specifically, as illustrated in FIG. 6 by way of example, the first magnet holding portion 70a has a pair of side surface holding portions 74a-1, 74a-2 and a pair of axial end surface holding portions 76a-1, 76a-2. Moreover, the second magnet holding portions 70b are each provided corresponding to the second permanent magnets 49b. Specifically, as illustrated in FIG. 6 by way of example, the second magnet holding portion 70b has a pair of side surface holding portions 74b-1, 74b-2 and a pair of axial end surface holding portions 76b-1, 76b-2.

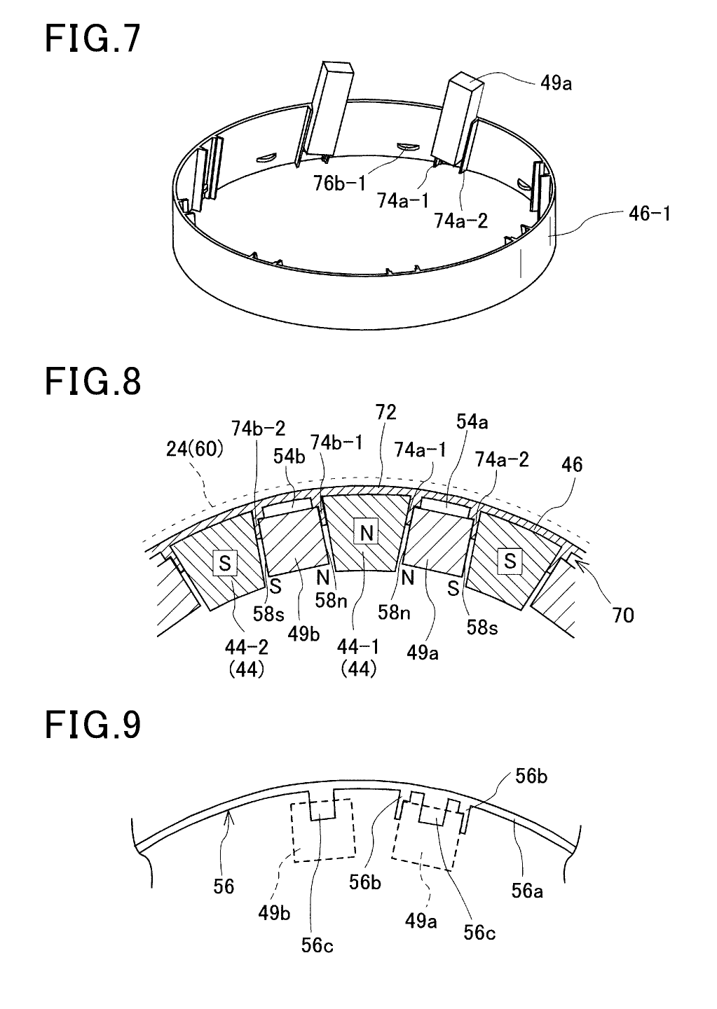

As illustrated in FIGS. 7 and 8 by way of example, the side surface holding portion 74a-1 extends inclined (inclined to the counterclockwise spiral direction in FIG. 6) along the shapes of the first clearance space 54a and the first permanent magnet 49a on the inner peripheral surface of the tubular body portion 72. The side surface holding portion 74a-1 is a holding portion facing the side surface portion 58n of the first permanent magnet 49a, the first permanent magnet 49a facing the first claw-shaped magnetic pole portion 44-1 in the circumferential direction, the side surface portion 58n being N-poles. The side surface holding portion 74a-2 extends inclined (inclined to the counterclockwise spiral direction in FIG. 6) along the shapes of the first clearance space 54a and the first permanent magnet 49a on the inner peripheral surface of the tubular body portion 72. The side surface holding portion 74a-2 is a holding portion facing the side surface portion 58s of the first permanent magnet 49a, the first permanent magnet 49a facing the second claw-shaped magnetic pole portion 44-2 in the circumferential direction, the side surface portion 58s being S-poles.

The pair of side surface holding portions 74a-1, 74a-2 holding the first permanent magnet 49a extends along the same counterclockwise spiral direction in accordance with the shapes of the first permanent magnet 49a and the first clearance space 54a. Such an extension direction is the same as a direction in which the first clearance space 54a and the first permanent magnet 49a extend. The side surface holding portion 74a-1 and the side surface holding portion 74a-2 are apart from each other in the circumferential direction by a distance corresponding to the circumferential width of the first permanent magnet 49a. The pair of side surface holding portions 74a-1, 74a-2 has the function of holding the first permanent magnet 49a with the first permanent magnet 49a being griped at the side surface 58n and the side surface 58s thereof in the circumferential direction.

Similarly, the side surface holding portion 74b-1 extends inclined (inclined to the clockwise spiral direction in FIG. 6) along the shapes of the second clearance space 54b and the second permanent magnet 49b on the inner peripheral surface of the tubular body portion 72. The side surface holding portion 74b-1 is a holding portion facing the side surface portion 58n of the second permanent magnet 49b, the second permanent magnet 49b facing the first claw-shaped magnetic pole portion 44-1 in the circumferential direction, the side surface portion 58n being N-poles. The side surface holding portion 74b-2 extends inclined (inclined to the clockwise spiral direction in FIG. 6) along the shapes of the second clearance space 54b and the second permanent magnet 49b on the inner peripheral surface of the tubular body portion 72. The side surface holding portion 74b-2 is a holding portion facing the side surface portion 58s of the second permanent magnet 49b, the second permanent magnet 49b facing the second claw-shaped magnetic pole portion 44-2 in the circumferential direction, the side surface portion 58s being N-poles.

The pair of side surface holding portions 74b-1, 74b-2 holding the second permanent magnet 49b extends along the same clockwise spiral direction in accordance with the shapes of the second permanent magnet 49b and the second clearance space 54b. Such an extension direction is the same as a direction in which the second clearance space 54b and the second permanent magnet 49b extend. The side surface holding portion 74b-1 and the side surface holding portion 74b-2 are apart from each other in the circumferential direction by a distance corresponding to the circumferential width of the second permanent magnet 49b. The pair of side surface holding portions 74b-1, 74b-2 has the function of holding the second permanent magnet 49b with the second permanent magnet 49b being griped at the side surface 58n and the side surface 58s thereof in the circumferential direction.

The side surface holding portions 74a-1, 74a-2 are formed between the first end (a lower end in FIG. 6) of the tubular body portion 72 of the outer peripheral iron core portion 46 in the axial direction and a center position in the axial direction. Moreover, the side surface holding portions 74b-1, 74b-2 are formed between the second end (an upper end in FIG. 6) of the tubular body portion 72 of the outer peripheral iron core portion 46 in the axial direction and the center position in the axial direction. An axial area where the side surface holding portions 74a-1, 74a-2 are positioned in the axial direction and an axial area where the side surface holding portions 74b-1, 74b-2 are positioned in the axial direction do not overlap with each other. Each of the side surface holding portions 74a-1, 74a-2, 74b-1, 74b-2 has an axial length corresponding to about ½ of the length of the tubular body portion 72 in the axial direction.

The axial end surface holding portion 76a-1 extends along the circumferential direction. The axial end surface holding portion 76a-1 is a holding portion of the first permanent magnet 49a facing an axial end surface 78e on the tip end side of the first claw-shaped magnetic pole portion 44-1 and the base side of the second claw-shaped magnetic pole portion 44-2. The axial end surface holding portion 76a-2 extends along the circumferential direction. The axial end surface holding portion 76a-2 is a holding portion of the first permanent magnet 49a facing an axial end surface 78w on the base side of the first claw-shaped magnetic pole portion 44-1 and the tip end side of the second claw-shaped magnetic pole portion 44-2.

The axial end surface holding portion 76a-1 and the axial end surface holding portion 76a-2 are apart from each other in the axial direction by a distance corresponding to the width of the first permanent magnet 49a in the axial direction. The axial end surface holding portion 76a-1 and the axial end surface holding portion 76a-2 are arranged shifted from each other in the circumferential direction by an amount corresponding to diagonal extension of the first permanent magnet 49a in the axial direction. The axial end surface holding portion 76a-1 and the axial end surface holding portion 76a-2 have the function of holding the first permanent magnet 49a with the first permanent magnet 49a being griped at the axial end surface 78w and the axial end surface 78e thereof in the axial direction.

Similarly, the axial end surface holding portion 76b-1 extends along the circumferential direction. The axial end surface holding portion 76b-1 is a holding portion of the second permanent magnet 49b facing the axial end surface 78e on the tip end side of the first claw-shaped magnetic pole portion 44-1 and the base side of the second claw-shaped magnetic pole portion 44-2. The axial end surface holding portion 76b-2 extends along the circumferential direction. The axial end surface holding portion 76b-2 is a holding portion of the second permanent magnet 49b facing the axial end surface 78w on the base side of the first claw-shaped magnetic pole portion 44-1 and the tip end side of the second claw-shaped magnetic pole portion 44-2.

The axial end surface holding portion 76b-1 and the axial end surface holding portion 76b-2 are apart from each other in the axial direction by a distance corresponding to the width of the second permanent magnet 49b in the axial direction. The axial end surface holding portion 76b-1 and the axial end surface holding portion 76b-2 are arranged shifted from each other in the circumferential direction by an amount corresponding to diagonal extension of the second permanent magnet 49b in the axial direction. The axial end surface holding portion 76b-1 and the axial end surface holding portion 76b-2 have the function of holding the second permanent magnet 49b with the second permanent magnet 49b being griped at the axial end surface 78w and the axial end surface 78e thereof in the axial direction.

The outer peripheral iron core portion 46 has such a structure that the multiple thin plate members 56 are stacked on each other in the axial direction as described above. The thin plate members 56 form the tubular body portion 72 and the side surface holding portions 74 of the outer peripheral iron core portion 46. That is, the tubular body portion 72 and the side surface holding portions 74 are formed in such a manner that the thin plate members 56 are stacked on each other in the axial direction. As illustrated in FIG. 9 by way of example, each thin plate member 56 has a circular ring portion 56a corresponding to the tubular body portion 72, and raised portions 56b corresponding to the side surface holding portions 74. Note that only some, or none of, the thin plate members 56 do not necessarily have the raised portions 56b. The thin plate members 56 arranged in the vicinity of both ends of the outer peripheral iron core portion 46 in the axial direction do not necessarily have the raised portions 56b. The circular ring portion 56a is formed in a circular ring shape. The raised portions 56b are formed to extend from an inner peripheral surface of the circular ring portion 56a toward the axial center.

In a case where the side surface holding portions 74 extending diagonally in the axial direction are formed using the multiple thin plate members 56, the shape may be slightly changed for each thin plate member 56, and these thin plate members 56 having different shapes may be stacked on each other in the axial direction. Alternatively, the positions of the thin plate members 56 having the same shape may be slightly shifted from each other in the circumferential direction, and these thin plate members 56 may be stacked on each other in the axial direction.

In the outer peripheral iron core portion 46, the raised portions 56b of the thin plate members 56 forming the side surface holding portions 74 are joined and bonded to each other along the axial direction by, e.g., welding or adhesive bonding in a state in which the multiple thin plate members 56 having the circular ring portions 56a and the raised portions 56b are stacked on each other in the axial direction. In this manner, the outer peripheral iron core portion 46 is integrated. Such joining or bonding is implemented by, e.g., welding to an inner peripheral surface of the outer peripheral iron core portion 46 provided with the side surface holding portions 74.

The axial end surface holding portions 76 are formed using some (e.g., one to three thin plate members 56) of all thin plate members 56 forming the outer peripheral iron core portion 46. These thin plate members 56 forming the axial end surface holding portions 76 are punched out in a shape different from that of the other thin plate members 56 (the thin plate members 56 not forming the axial end surface holding portions 76). Specifically, as illustrated in FIG. 9 by way of example, the thin plate members 56 have raised portions 56c corresponding to the axial end surface holding portions 76.

The axial end surface holding portion 76a-1 corresponding to the first permanent magnet 49a and the axial end surface holding portion 76b-1 corresponding to the second permanent magnet 49b are arranged apart from each other in the circumferential direction at the same axial position. In this configuration, the axial end surface holding portion 76a-1 and the axial end surface holding portion 76b-1 may be formed using the same type of thin plate member 56. Moreover, the axial end surface holding portion 76a-2 corresponding to the first permanent magnet 49a and the axial end surface holding portion 76b-2 corresponding to the second permanent magnet 49b are arranged apart from each other in the circumferential direction at the same axial position. In this configuration, the axial end surface holding portion 76a-2 and the axial end surface holding portion 76b-2 may be formed using the same type of thin plate member 56.

The axial end surface holding portions 76 may be, as described above, formed using the thin plate members 56 punched out to have the raised portions 56c in advance. Alternatively, the axial end surface holding portions 76 may be, for example, formed in such a manner that after the outer peripheral iron core portion 46 has been temporarily formed using the thin plate members 56 having no raised portions 56c, portions to be formed as the axial end surface holding portions 76 in the formed outer peripheral iron core portion 46 are pressed from an outer peripheral side by a pressing device.

Each of the side surface holding portions 74 and the axial end surface holding portions 76 of the outer peripheral iron core portion 46 may have such a radial height that the side surface holding portions 74 and the axial end surface holding portions 76 can hold the permanent magnets 49. Each of the raised portions 56b, 56c of the thin plate members 56 may be formed to have such a radial length that the raised portions 56b, 56c can hold the permanent magnets 49. For example, the radial height or the radial length is set to a value corresponding to about ½ of the axial width of the side surface 58n, 58s or the axial end surface 78w, 78e of the permanent magnet 49.

As illustrated in FIG. 6 by way of example, the outer peripheral iron core portion 46 is formed in such a manner that cylindrical divided iron core portions 46-1, 46-2 divided in half in the axial direction are bonded at the center position of the outer peripheral iron core portion 46 in the axial direction. Such bonding of the divided iron core portions 46-1, 46-2 may be performed using an adhesive, for example. Alternatively, such bonding may be performed by welding. The first divided iron core portion 46-1 has the pairs of side surface holding portions 74a-1, 74a-2 and the axial end surface holding portions 76a-1 of the first magnet holding portions 70a and the axial end surface holding portions 76b-1 of the second magnet holding portions 70b. Moreover, the second divided iron core portion 46-2 has the axial end surface holding portions 76a-2 of the first magnet holding portions 70a and the pairs of side surface holding portions 74b-1, 74b-2 and the axial end surface holding portions 76b-2 of the second magnet holding portions 70b.

As described above, in the structure of the rotor 20 of the present embodiment, the permanent magnet 49 arranged between adjacent ones of the claw-shaped magnetic pole portions 44 is held by the magnet holding portion 70 provided integrally with the outer peripheral iron core portion 46. Specifically, the side surfaces 58n, 58s of the permanent magnet 49 are, in contact with the pair of side surface holding portions 74a-1, 74a-2 of the outer peripheral iron core portion 46, sandwiched between the side surface holding portions 74a-1, 74a-2 in the circumferential direction. In addition, the axial end surfaces 78w, 78e of the permanent magnet 49 are in contact with the pair of axial end surface holding portions 76a-1, 76a-2 of the outer peripheral iron core portion 46, sandwiched between the axial end surface holding portions 76a-1, 76a-2 in the axial direction. In this manner, the permanent magnets 49 are held.

The above-described magnet holding portions 70 are made of a soft magnetic material as in the tubular body portion 72 of the outer peripheral iron core portion 46. In this case, the magnet holding portion 70 holding the permanent magnet 49 is arranged as the iron core. Specifically, the magnet holding portion 70 is arranged along the side surfaces 58n, 58s and the axial end surfaces 78w, 78e of the permanent magnet 49. In this configuration of the rotor 20, the magnet holding portion 70 holding the permanent magnet 49 is not formed from a non-magnetic body such as austenite or SUS in the present embodiment. Thus, in the rotor 20 of the present embodiment, magnetic resistance of the magnetic circuit formed for each permanent magnet 49 can be reduced. That is, in the rotor 20 of the present embodiment, the magnetic resistance of the magnetic circuit for a flow in the order of the permanent magnets 49, the first claw-shaped magnetic pole portions 44-1, the stator iron core 60, the second claw-shaped magnetic pole portions 44-2, and the permanent magnets 49 can be reduced.

The magnet holding portion 70 has the pair of side surface holding portions 74a-1, 74a-2 and the pair of axial end surface holding portions 76a-1, 76a-2. Moreover, the magnet holding portion 70 holds the permanent magnet 49 at the surfaces in close contact with the permanent magnet 49. The pair of side surface holding portions 74a-1, 74a-2 and the pair of the axial end surface holding portions 76a-1, 76a-2 are arranged on four sides of the substantially rectangular parallelepiped permanent magnet 49. In this configuration of the rotor 20, no large gap is formed between the permanent magnet 49 and the claw-shaped magnetic pole portion 44 in the present embodiment. Thus, in the rotor 20 of the present embodiment, the magnetic resistance of the magnetic circuit passing through the permanent magnets 49 as described above can be reduced.

The magnet holding portion 70 is formed in such a manner that the thin plate members 56 punched out in a desired shape are stacked on each other in the axial direction. Thus, in the rotor 20 of the present embodiment, the magnet holding portion 70 is not made of a material subjected to bending or rolling. Consequently, in the rotor 20 of the present embodiment, degradation of magnetic properties can be prevented, and magnetic force can be improved.

Thus, in the rotor 20 of the present embodiment, the permanent magnet 49 can be held between adjacent ones of the claw-shaped magnetic pole portions 44 by the magnet holding portion 70. Moreover, in the rotor 20 of the present embodiment, such a magnet holding portion 70 is formed from a magnetic body such that permeance of the magnetic circuit passing through the permanent magnets 49 is increased.

If bonding such a welding is performed on an outer peripheral side of the outer peripheral iron core portion 46, the thin plate members 56 are bonded to each other at a thin portion of the outer peripheral iron core portion 46. In this case, disturbance in the magnetic flux flow due to a skin effect is easily caused on an outer peripheral side of the rotor 20 facing an inner peripheral surface of the stator 24. For this reason, the magnetic properties are degraded. Moreover, strength at a welded position is generally lowered. Thus, there is a probability that strength on a tubular body portion 72 side of the outer peripheral iron core portion 46 to which stress on the claw-shaped magnetic pole portions 44 or the permanent magnets 49 due to centrifugal force in association with rotation of the rotating electrical machine 22 is provided is lowered.

In response, in the rotor 20 of the present embodiment, the outer peripheral iron core portion 46 is formed in such a manner that in a state in which the multiple thin plate members 56 are stacked on each other in the axial direction, the raised portions 56b of the thin plate members 56 forming the side surface holding portions 74 on inner peripheral surfaces of the thin plate members 56 are joined and bonded along the axial direction by welding or adhesive bonding. In this manner, the outer peripheral iron core portion 46 is integrated. In this case, the thin plate members 56 are bonded at a thick portion of the outer peripheral iron core portion 46.

Thus, the rotor 20 of the present embodiment has strength increased as compared to a configuration in which the thin plate members 56 are not joined to each other. Moreover, in the present embodiment, in the case of bonding the thin plate members 56 to each other, no bonding such as welding is performed on the tubular body portion 72 side (the outer peripheral side) of the outer peripheral iron core portion 46. Thus, in the rotor 20 of the present embodiment, lowering of the strength on the tubular body portion 72 side is suppressed. Moreover, disturbance in the magnetic flux flow due to the skin effect is reduced. Thus, the rotor 20 of the present embodiment can ensure favorable magnetic properties. The side surface holding portions 74 and the axial end surface holding portions 76 of the magnet holding portions 70 as the thick portion of the outer peripheral iron core portion 46 are present at portions on which the stress on the claw-shaped magnetic pole portions 44 or the permanent magnets 49 due to the centrifugal force generated in association with rotation of the rotor 20 is concentrated. Thus, in the present embodiment, the strength of the rotor 20 is reinforced by the magnet holding portions 70.

In the rotor 20 of the present embodiment, the magnet holding portion 70 holding the permanent magnet 49 has the side surface holding portions 74 and the axial end surface holding portions 76. The side surface holding portions 74 are arranged along the side surfaces 58n, 58s of the permanent magnet 49. The axial end surface holding portions 76 are arranged along the axial end surfaces 78w, 78e of the permanent magnet 49. Thus, the rotor 20 of the present embodiment can provide the detachment prevention function of preventing detachment of the permanent magnets 49 in the circumferential direction using the side surface holding portions 74 of the magnet holding portions 70. Moreover, the axial end surface holding portions 76 can provide the detachment prevention function of preventing detachment of the permanent magnets 49 in the axial direction.

In particular, end portions of the permanent magnet 49 in the axial direction are low-permeance portions where the magnetic flux is less circulated. Thus, there is a probability that magnetizing current necessary for magnetizing the permanent magnet 49 is increased. In response, in the rotor 20 of the present embodiment, the axial end surface holding portions 76 as the iron core are, as described above, arranged along the axial end surfaces 78w, 78e of the permanent magnet 49. Thus, in the rotor 20 of the present embodiment, the permeance of the magnetic circuit passing through the permanent magnets 49 is increased due to the presence of the axial end surface holding portions 76. Moreover, in the rotor 20 of the present embodiment, the magnetizing current for magnetizing the permanent magnets 49 can be reduced while such magnetization of the permanent magnets 49 can be ensured.

In the rotor 20 of the present embodiment, the outer peripheral iron core portion 46 includes the cylindrical divided iron core portions 46-1, 46-2 divided in half in the axial direction. The first divided iron core portion 46-1 has the pairs of side surface holding portions 74a-1, 74a-2 and the axial end surface holding portions 76a-1 of the first magnet holding portions 70a and the axial end surface holding portions 76b-1 of the second magnet holding portions 70b. In addition, the second divided iron core portion 46-2 has the axial end surface holding portions 76a-2 of the first magnet holding portions 70a and the pairs of side surface holding portions 74b-1, 74b-2 and the axial end surface holding portions 76b-2 of the second magnet holding portions 70b.

The side surface holding portions 74a-1, 74a-2 formed at the first divided iron core portion 46-1 extend in the counterclockwise spiral direction. Moreover, the side surface holding portions 74b-1, 74b-2 formed at the second divided iron core portion 46-2 extend in the clockwise spiral direction. Assembly of the outer peripheral iron core portion 46 with the outer periphery of the claw-shaped magnetic pole portions 44 is performed in such a manner that the first divided iron core portion 46-1 is inserted from a first side (the lower side in FIG. 6) of the claw-shaped magnetic pole portion 44 in the axial direction while rotating in the counterclockwise spiral direction. Moreover, the second divided iron core portion 46-2 is inserted from a second side (the upper side in FIG. 6) of the claw-shaped magnetic pole portion 44 in the axial direction while rotating in the clockwise spiral direction. Then, after such insertion has been completed, the first divided iron core portion 46-1 and the second divided iron core portion 46-2 are bonded by, e.g., adhesive bonding or welding at the center position of the outer peripheral iron core portion 46 in the axial direction.

In insertion of the outer peripheral iron core portion 46 onto the outer periphery of the claw-shaped magnetic pole portions 44, both of the first divided iron core portion 46-1 and the second divided iron core portion 46-2 may be inserted from only either one of a first side and a second side of the claw-shaped magnetic pole portion 44 in the axial direction. For example, the first divided iron core portion 46-1 to be arranged on a first side (the lower side in FIG. 6) of the claw-shaped magnetic pole portion 44 in the axial direction is first inserted from a second side (the upper side in FIG. 6) of the claw-shaped magnetic pole portion 44 in the axial direction while rotating in the counterclockwise spiral direction. After such insertion has been completed, the second divided iron core portion 46-2 to be arranged on the second side (the upper side in FIG. 6) of the claw-shaped magnetic pole portion 44 in the axial direction is inserted while rotating in the clockwise spiral direction.

In this structure of the rotor 20, each of the first divided iron core portion 46-1 and the second divided iron core portion 46-2 is, in the present embodiment, inserted and arranged on the claw-shaped magnetic pole portions 44, and are bonded to each other at the center position of the outer peripheral iron core portion 46 in the axial direction. Thus, in the present embodiment, even when the claw-shaped magnetic pole portions 44 attempt to rotate in any direction of the circumferential direction relative to the outer peripheral iron core portion 46 including the first divided iron core portion 46-1 and the second divided iron core portion 46-2, such relative rotation is blocked. That is, when the claw-shaped magnetic pole portions 44 attempt to rotate relative to the outer peripheral iron core portion 46 in a direction in which rotation relative to the first divided iron core portion 46-1 is allowed, such rotation is blocked by the presence of the second divided iron core portion 46-2. Moreover, when the claw-shaped magnetic pole portions 44 attempt to rotate relative to the outer peripheral iron core portion 46 in a direction in which rotation relative to the second divided iron core portion 46-2 is allowed, such rotation is blocked by the presence of the first divided iron core portion 46-1.

Thus, the rotor 20 of the present embodiment can provide the anti-rotation function of preventing the claw-shaped magnetic pole portions 44 from rotating relative to the outer peripheral iron core portion 46 after the outer peripheral iron core portion 46 has been arranged and assembled on the outer peripheral side of the claw-shaped magnetic pole portions 44.

The stress on the claw-shaped magnetic pole portions 44 or the permanent magnets 49 due to the centrifugal force is concentrated on tip ends of the claw-shaped magnetic pole portions 44 in the axial direction. Thus, stress acting on the center position in the axial direction is relatively small. Consequently, lowering of the strength of the rotor 20 can be suppressed in the structure in which the first divided iron core portion 46-1 and the second divided iron core portion 46-2 of the outer peripheral iron core portion 46 are bonded at the center position in the axial direction by adhesive bonding or welding as in the present embodiment.

In a case where the field winding 48 or the stator winding 62 is fixed by varnish application and curing and the shape of the field winding 48 or the stator winding 62 is fixed accordingly, the following method may be employed. A device configured to apply varnish executes the fixing step of fixing the winding 48, 62 by means of the varnish and the bonding step of bonding the first divided iron core portion 46-1 and the second divided iron core portion 46-2 by means of the varnish. The fixing step and the bonding step may be executed at the substantially same timing. According to this configuration, a device configured to manufacture the rotor 20 and the step of manufacturing the rotor 20 are simplified.

As clearly seen from description above, the rotor 20 of the present embodiment includes the multiple claw-shaped magnetic pole portions 44, 44-1, 44-2, the permanent magnets 49, 49a, 49b, and the tubular outer peripheral iron core portion 46. The claw-shaped magnetic pole portions 44, 44-1, 44-2 face the stator 24 in the radial direction, are arranged with the clearance spaces 54, 54a, 54b in the circumferential direction, and are alternately magnetized to different magnetic polarities in the circumferential direction by power application to the field winding 48. The permanent magnets 49, 49a, 49b are each arranged in the clearance spaces 54, 54a, 54b such that the polarity of each of the side surfaces 58n, 58s facing the claw-shaped magnetic pole portions 44, 44-1, 44-2 in the circumferential direction is the same as the polarity of a corresponding one of the claw-shaped magnetic pole portions 44, 44-1, 44-2. The outer peripheral iron core portion 46 covers the outer peripheral side of the claw-shaped magnetic pole portions 44, 44-1, 44-2. The outer peripheral iron core portion 46 has the tubular body portion 72 and the magnet holding portions 70, 70a, 70b holding the permanent magnets 49, 49a, 49b.

According to this configuration, in the rotor 20 of the present embodiment, the permanent magnet 49 can be held between adjacent ones of the claw-shaped magnetic pole portions 44 by the magnet holding portion 70 of the outer peripheral iron core portion 46. Moreover, the magnet holding portion 70 is arranged as the iron core along the surfaces of the permanent magnet 49, and closely contacts such a permanent magnet 49. Thus, in the rotor 20 of the present embodiment, the magnetic resistance of the magnetic circuit passing through the permanent magnets 49 can be more reduced as compared to a structure in which the magnet holding portion 70 is formed from the non-magnetic body or a structure in which a large gap is formed between the permanent magnet 49 and the claw-shaped magnetic pole portion 44. Thus, in the rotor 20 of the present embodiment, the permanent magnet 49 is held between adjacent ones of the claw-shaped magnetic pole portions 44 by the magnet holding portion 70 while the permeance of the magnetic circuit passing through the permanent magnets 49 is increased.

Moreover, in the rotor 20 of the present embodiment, the magnet holding portion 70 is formed to protrude from the inner peripheral surface of the tubular body portion 72 of the outer peripheral iron core portion 46 toward the radial outside and to grip the permanent magnet 49. According to this configuration, the rotor 20 of the present embodiment can grip and hold the permanent magnet 49 between adjacent ones of the claw-shaped magnetic pole portions 44 by the magnet holding portion 70 protruding from the inner peripheral surface of the tubular body portion 72 of the outer peripheral iron core portion 46 toward the radial inside.

Further, in the rotor 20 of the present embodiment, the outer peripheral iron core portion 46 has such a structure that the soft magnetic thin plate members 56 are stacked on each other in the axial direction. The outer peripheral iron core portion 46 is integrated in such a manner that the thin plate members 56 are bonded together along the axial direction at the magnet holding portions 70. According to this configuration, in the rotor 20 of the present embodiment, bonding of the thin plate members 56 by welding etc. is not performed on the outer peripheral side of the outer peripheral iron core portion 46. Thus, in the rotor 20 of the present embodiment, disturbance in the magnetic flux flow due to the skin effect is reduced, and favorable magnetic properties can be ensured. The magnet holding portions 70 as the thick portion of the outer peripheral iron core portion 46 are present at the portions on which the stress due to the centrifugal force in association with rotation of the rotating electrical machine 22 is concentrated. Thus, in the present embodiment, the strength of the rotor 20 is reinforced.

In the rotor 20 of the present embodiment, the magnet holding portion 70 has the side surface holding portions 74 facing the side surfaces 58n, 58s of the permanent magnet 49 and extending along the axial direction. According to this configuration, the rotor 20 of the present embodiment can hold the permanent magnets 49 in the circumferential direction using the side surface holding portions 74.

In the rotor 20 of the present embodiment, the claw-shaped magnetic pole portions 44 have the first claw-shaped magnetic pole portions 44-1 and the second claw-shaped magnetic pole portions 44-2. The first claw-shaped magnetic pole portions 44-1 and the second claw-shaped magnetic pole portions 44-2 are formed such that the circumferential width changes from the base side in the axial direction to the tip end side in the axial direction. Moreover, the first claw-shaped magnetic pole portions 44-1 and the second claw-shaped magnetic pole portions 44-2 are alternately arranged in the circumferential direction such that the position of the base side in the axial direction and the position of the tip end side in the axial direction are on the opposite sides in the axial direction, and are magnetized to different magnetic polarities. The clearance spaces 54 have the first clearance spaces 54a and the second clearance spaces 54b. The first clearance spaces 54a and the second clearance spaces 54b are inclined from a first side to a second side in the axial direction at the predetermined angle with respect to the rotation axis. Moreover, the first clearance spaces 54a and the second clearance spaces 54b are provided in different skew directions inclined with respect to the rotation axis. The outer peripheral iron core portion 46 has such a structure that the cylindrical first divided iron core portion 46-1 and the cylindrical second divided iron core portion 46-2 divided in half in the axial direction are bonded at the center position in the axial direction. The first divided iron core portion 46-1 has the side surface holding portions 74a-1, 74a-2 holding the first permanent magnets 49a arranged in the first clearance spaces 54a. The second divided iron core portion 46-2 has the side surface holding portions 74b-1, 74b-2 holding the second permanent magnets 49b arranged in the second clearance spaces 54b.

According to this configuration, in the rotor 20 of the present embodiment, each of the permanent magnets 49a, 49b arranged in the first clearance spaces 54a and the second clearance spaces 54b in different skew directions inclined with respect to the rotation axis is held by the side surface holding portions 74a-1, 74a-2, 74b-1, 74b-2 of the divided iron core portions 46-1, 46-2 as separated bodies divided in half in the axial direction.

In the rotor 20 of the present embodiment, the first divided iron core portion 46-1 is formed such that the first permanent magnet 49a is held by the side surface holding portions 74a-1, 74a-2 in a state in which the first divided iron core portion 46-1 is inserted onto the claw-shaped magnetic pole portions 44 by rotation in the counterclockwise spiral direction corresponding to the skew direction of the first clearance space 54a. The second divided iron core portion 46-2 is formed such that the second permanent magnet 49b is held by the side surface holding portions 74b-1, 74b-2 in a state in which the second divided iron core portion 46-2 is inserted onto the claw-shaped magnetic pole portions 44 by rotation in the clockwise spiral direction corresponding to the skew direction of the second clearance space 54b.

According to this configuration, in the rotor 20 of the present embodiment, each of the first divided iron core portion 46-1 and the second divided iron core portion 46-2 divided in half in the axial direction can be inserted onto the claw-shaped magnetic pole portions 44 by rotation in the spiral direction (specifically the spiral directions opposite to each other) corresponding to the skew direction of the clearance space 54, and both of the divided iron core portions 46-1, 46-2 can be bonded at the center position in the axial direction. Moreover, the rotor 20 of the present embodiment can provide the anti-rotation function of preventing the claw-shaped magnetic pole portions 44 from rotating in the circumferential direction relative to the outer peripheral iron core portion 46 including the first divided iron core portion 46-1 and the second divided iron core portion 46-2 after bonding of both of the divided iron core portions.

In the rotor 20 of the present embodiment, the magnet holding portion 70 has the axial end surface holding portions 76 facing the axial end surfaces 78w, 78e of the permanent magnet 49 and extending along the circumferential direction. According to this configuration, in the rotor 20 of the present embodiment, the permanent magnet 49 can be held in the axial direction using the axial end surface holding portions 76.

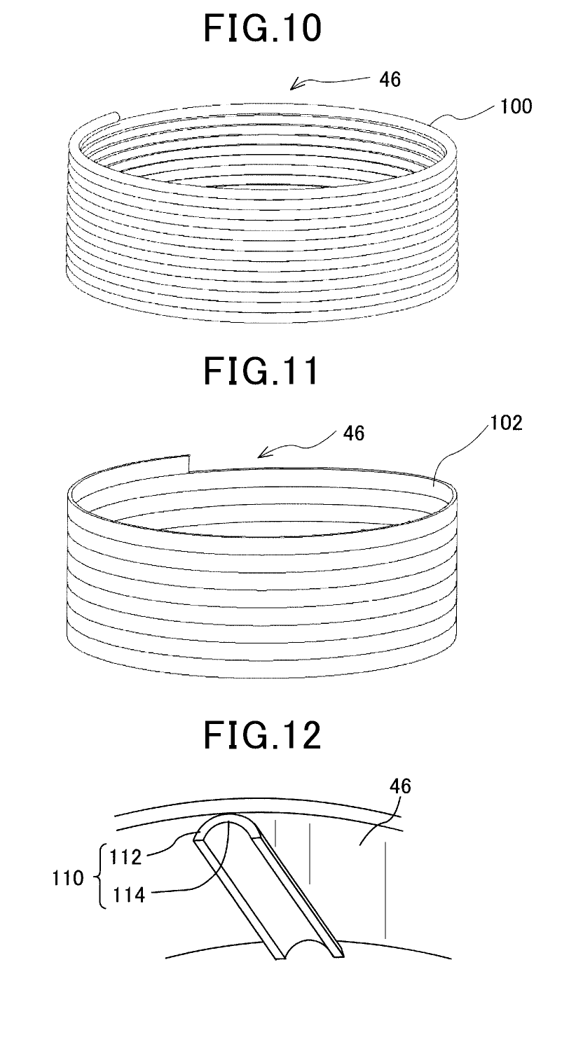

In the above-described embodiment, the outer peripheral iron core portion 46 has such a structure that the multiple soft magnetic thin plate members 56 such as the magnetic steel sheets are stacked on each other in the axial direction. However, the technique of the present disclosure is not limited to above. The outer peripheral iron core portion 46 may have, for example, a structure in which a stack in the axial direction is formed in such a manner that a single soft magnetic linear member 100 (see FIG. 10) or a single band-shaped member 102 (see FIG. 11) is spirally wound about the axis. That is, the outer peripheral iron core portion 46 may be formed from the soft magnetic linear member 100 or the band-shaped member 102 spirally wound to form the stack in the axial direction. In this case, the linear member 100 or the band-shaped member 102 is spirally wound about the axis on the outer peripheral side of the claw-shaped magnetic pole portions 44 while turns of the linear member 100 or the band-shaped member 102 are arranged with no clearances or slight clearances in the axial direction.

In the above-described variation, the single linear member 100 or the single band-shaped member 102 may be formed as follows. Specifically, the single linear member 100 or the single band-shaped member 102 may be formed such that portions corresponding to the magnet holding portions 70 are provided at corresponding portions and are arranged diagonally in the axial direction upon spiral winding. Moreover, in this configuration, stacked portions of the linear member 100 or stacked portions of the band-shaped member 102 at the magnet holding portions 70 may be bonded along the axial direction to integrate the outer peripheral iron core portion 46. Further, in this configuration, tension of the linear member 100 or the band-shaped member 102 is held constant at the manufacturing step of winding the linear member 100 or the band-shaped member 102 around the outer peripheral side of the claw-shaped magnetic pole portions 44. Thus, both of the quality and productivity of the rotor 20 are ensured. Note that the linear member 100 or the band-shaped member 102 forming the outer peripheral iron core portion 46 is preferably a block having a rectangular section, considering the strength and the magnetic performance. However, the present disclosure is not limited to above. For example, the linear member 100 or the band-shaped member 102 may be in a round wire shape or a shape with curved corner portions.

In the above-described embodiment, the outer peripheral iron core portion 46 has such a structure that the thin plate members 56 are stacked in the axial direction. Moreover, the outer peripheral iron core portion 46 is, as a whole, formed in a cylindrical shape, and has the magnet holding portions 70 on the inner peripheral side. However, the technique of the present disclosure is not limited to above. The outer peripheral iron core portion 46 may be formed from a cylindrical member configured such that components are integrated in the axial direction, and may have the magnet holding portions 70 on the inner peripheral side.

In the above-described embodiment, the following configuration is employed. Specifically, the outer peripheral iron core portion 46 has such a structure that the multiple thin plate members 56 are stacked on each other in the axial direction. Each of the thin plate members 56 has the raised portions 56b corresponding to the side surface holding portions 74 of the magnet holding portion 70 and the raised portion 56c corresponding to the axial end surface holding portion 76. The magnet holding portion 70 is provided integrally with the inner peripheral surface of the tubular body portion 72 of the outer peripheral iron core portion 46, and the magnet holding portions 70 and the tubular body portion 72 are formed from the single component. However, the technique of the present disclosure is not limited to above.

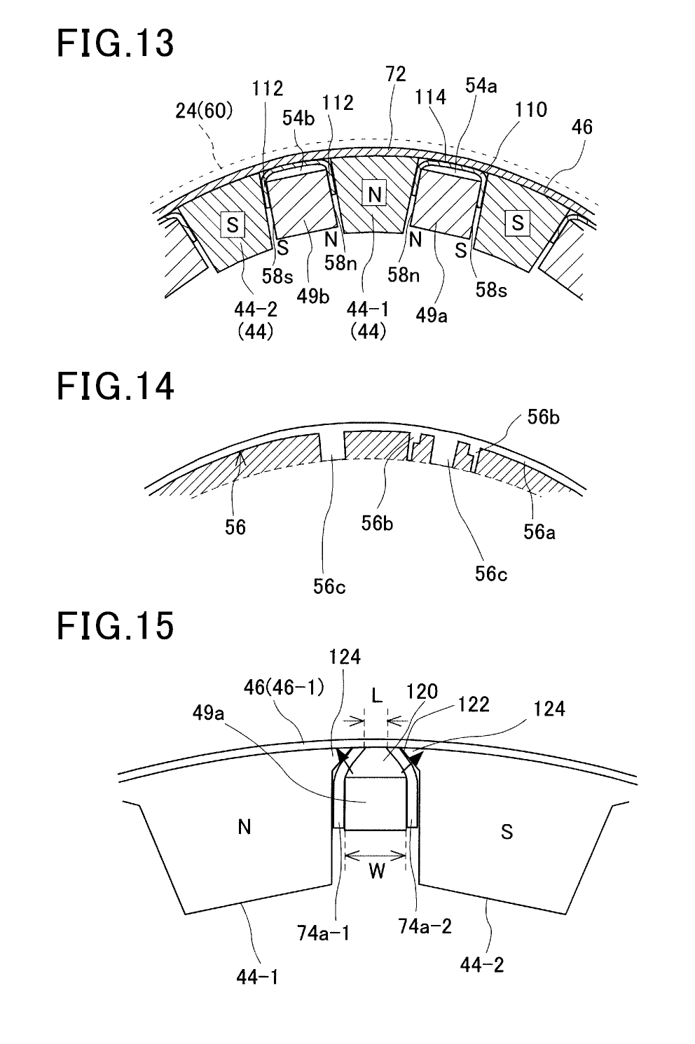

In a variation having the above-described configuration, a magnet holding portion 110 for holding the permanent magnet 49 and the tubular body portion 72 may be formed from different components as illustrated in FIGS. 12 and 13 by way of example without the thin plate members 56 of the outer peripheral iron core portion 46 having the raised portions 56b, 56c, for example. Specifically, the tubular body portion 72 has such a structure that the multiple thin plate members 56 are stacked on each other in the axial direction. The magnet holding portion 110 is not necessarily formed from the multiple thin plate members 56. The magnet holding portion 110 may extend along the axial direction, and may be formed from a component (e.g., a component formed with a U-shaped section) formed separately from the tubular body portion 72. That is, the magnet holding portion 110 (particularly the side surface holding portions 74) may extend inclined with respect to the rotation axis of the rotor 20, and the entirety of the magnet holding portion 110 may be formed integrally. Note that in this structure, the axial end surface holding portions 76 may be formed integrally with the side surface holding portions 74. The magnet holding portion 110 is, by welding, adhesive bonding, etc., bonded to the inner peripheral surface of the tubular body portion 72 configured such that the thin plate members 56 are stacked on each other in the axial direction.

The magnet holding portion 110 has a pair of side surface holding portions 112 corresponding to the side surface holding portions 74 of the magnet holding portion 70, a pair of axial end surface holding portions (not shown) corresponding to the axial end surface holding portions 76 of the magnet holding portion 70, and a flat plate-shaped base portion 114 joined in contact with the inner peripheral surface of the tubular body portion 72. The side surface holding portions 112 in a pair face each other with respect to the base portion 114 in the circumferential direction. Moreover, the axial end surface holding portions in a pair face each other with respect to the base portion 114 in the axial direction.

The magnet holding portion 110 and the tubular body portion 72 may be made of different materials. Alternatively, the magnet holding portion 110 and the tubular body portion 72 may be made of the same material. When the magnet holding portion 110 and the tubular body portion 72 are made of the same material, the magnet holding portion 110 and the tubular body portion 72 are produced by different steps, and have different structures.

If the thin plate member 56 has, as in the above-described embodiment, the raised portions 56b corresponding to at least the side surface holding portions 74 of the magnet holding portion 70 and the magnet holding portions 70 and the tubular body portion 72 are formed from a single component, a step in manufacturing of the outer peripheral iron core portion 46 provided with the magnet holding portions 70 can be simplified. However, in order for the raised portions 56b to be formed on an inner peripheral side of the thin plate members 56, circular ring members need to be punched out such that the raised portions 56b are formed. Thus, after punching out, each portion (shaded portions in FIG. 14) between adjacent ones of the raised portions 56b is an unnecessary portion. Thus, the yield rate when producing the outer peripheral iron core portion 46 is lowered.

On the other hand, in the above-described variation, the magnet holding portion 110 and the tubular body portion 72 of the outer peripheral iron core portion 46 are formed from different components as described above. Thus, the raised portions 56b corresponding to the magnet holding portions 110 are not necessarily formed on the inner peripheral side of the thin plate members 56. Consequently, the circular ring members as the material of the thin plate members 56 do not need to be punched out such that the raised portions 56b are formed. With this configuration, in the present variation, waste material upon formation of the outer peripheral iron core portion 46 can be reduced, and the yield rate when producing the outer peripheral iron core portion 46 can be improved. Moreover, in the present variation, the material of the linear member 100 and the material of the tubular body portion 72 can be changed as necessary.

In the above-described embodiment, the magnet holding portion 70 is formed to protrude from the inner peripheral surface of the tubular body portion 72 of the outer peripheral iron core portion 46 toward the radial inside, and the permanent magnet 49 is formed in the substantially rectangular parallelepiped shape. However, the technique of the present disclosure is not limited to above. As illustrated in FIG. 15 by way of example, the magnet holding portion 70 is formed with a tapered section to divide a space between the permanent magnet 49 and the tubular body portion 72 of the outer peripheral iron core portion 46 into an internal space 120 where the permanent magnet 49 is held and a predetermined space 122 formed on the outside of the internal space 120 in the radial direction. The claw-shaped magnetic pole portion 44 has a tapered portion 124 arranged to fill the predetermined space 122.

The pair of side surface holding portions 74a-1, 74a-2 of the magnet holding portion 70 may be formed such that a distance L between positions continuously connected to the tubular body portion 72 of the outer peripheral iron core portion 46 is shorter than a distance (an opening distance) between inner tip ends of the side surface holding portions 74a-1, 74a-2 in the radial direction and is shorter than the circumferential width W of the permanent magnet 49. Alternatively, the tapered portion 124 of the claw-shaped magnetic pole portion 44 may be provided at each end of the claw-shaped magnetic pole portion 44 in the circumferential direction on the radial outside. Alternatively, the circumferential width W may be formed greater toward the radial outside.

In the above-described variation, the permanent magnet 49 (particularly corner portions on the radial outside) is supported in contact with inner wall surfaces of the side surface holding portions 74 in the internal space 120, the tapered portion 124 of the claw-shaped magnetic pole portion 44 being present on the outside of the internal space 120 in the radial direction. Thus, in the present variation, even when the stress on the permanent magnet 49 due to the centrifugal force in association with rotation of the rotating electrical machine 22 is generated, such stress is also provided not only to the outer peripheral iron core portion 46 but also to the tapered portion 124 of the claw-shaped magnetic pole portion 44.

Thus, in the above-described variation, the stress on the permanent magnet 49 due to the centrifugal force is dispersed to the outer peripheral iron core portion 46 and the claw-shaped magnetic pole portions 44. Consequently, in the present variation, the strength of the rotor 20 is improved. Alternatively, in the present variation, the width of the tubular body portion 72 of the outer peripheral iron core portion 46 in the radial direction can be decreased within a range where predetermined strength is ensured. A smaller width of the tubular body portion 72 of the outer peripheral iron core portion 46 in the radial direction results in a smaller amount of material injected upon formation of the outer peripheral iron core portion 46. Moreover, the magnetic flux leaking from the outer peripheral iron core portion 46 is decreased.

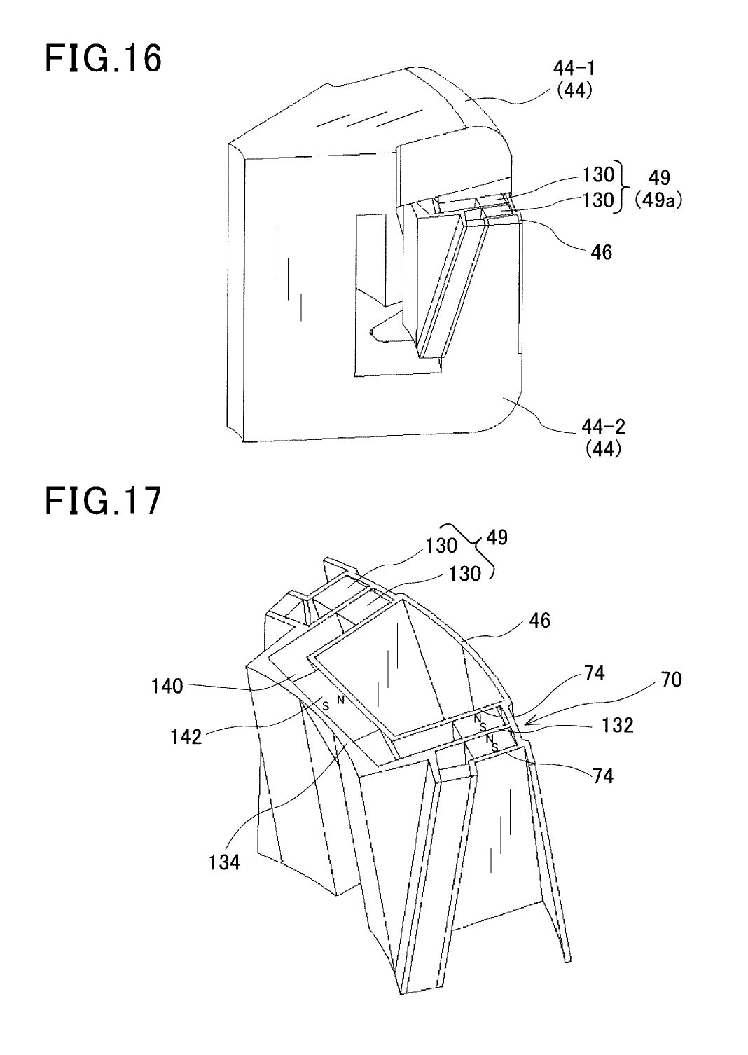

In the above-described embodiment, the permanent magnet 49 arranged in each clearance space 54 between adjacent ones of the claw-shaped magnetic pole portions 44 has a single structure formed in the substantially rectangular parallelepiped shape. However, the technique of the present disclosure is not limited to above. As illustrated in FIGS. 16 and 17 by way of example, the permanent magnet 49 for each clearance space 54 may be divided into two or more magnets in the circumferential direction by a q-axis at a position shifted from a d-axis passing through the center of the claw-shaped magnetic pole portion 44 in the circumferential direction by an electrical angle of 90°. That is, the permanent magnet 49 may include multiple divided magnets 130.

In the above-described variation, the magnet holding portion 70 of the outer peripheral iron core portion 46 is formed to hold the permanent magnet 49 including the multiple divided magnets 130 and to surround the claw-shaped magnetic pole portion 44 from the radial inside. Moreover, the magnet holding portion 70 is formed to have an iron core portion at which a q-axis magnetic circuit passing through the q-axis is formed. This is suitable for generation of reluctance torque. That is, the magnet holding portion 70 may have the side surface holding portions 74, a partition portion 132, and an annular portion 134. The side surface holding portion 74 contacts the side surface 58n, 58s of the permanent magnet 49 facing the claw-shaped magnetic pole portion 44. The partition portion 132 extends, between the divided magnets 130 divided in the circumferential direction, in the radial direction to penetrate the permanent magnet 49. The annular portion 134 extends in the circumferential direction to couple inner ends of the partition portions 132 in the radial direction. The partition portions 132 and the annular portion 134 form an iron core portion formed to surround the claw-shaped magnetic pole portion 44 and forming the q-axis magnetic circuit passing through the q-axis.

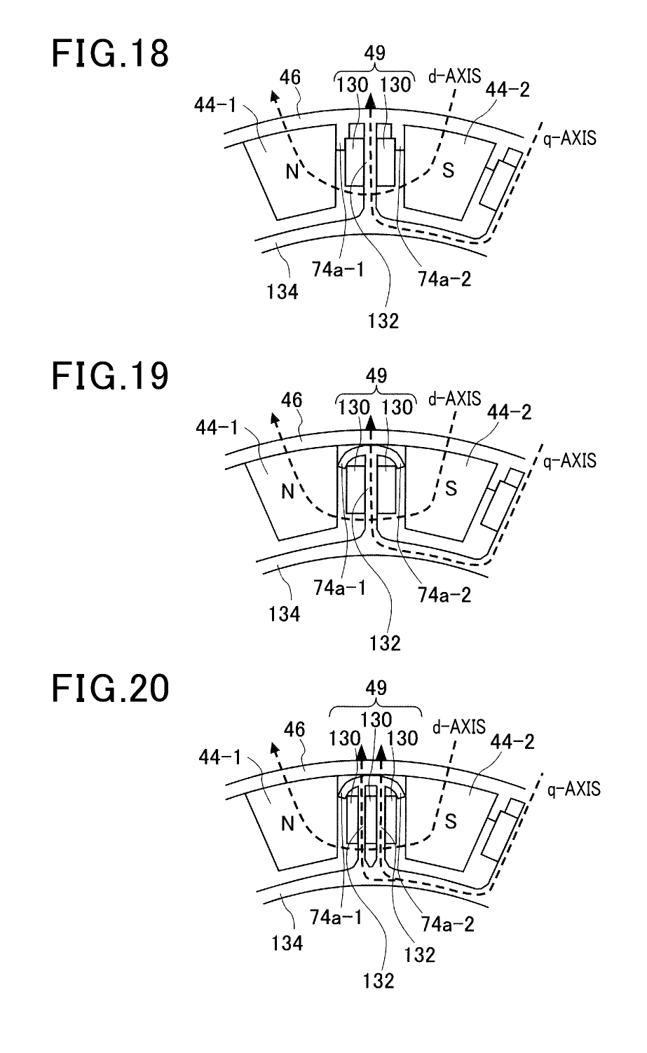

As illustrated in FIG. 18 by way of example, the magnet holding portion 70 is provided integrally with the outer peripheral iron core portion 46. The permanent magnet 49 includes the divided magnets 130 divided in half in the circumferential direction at the q-axis. The partition portion 132 of the magnet holding portion 70 extends in the radial direction to pass between the divided magnets 130 divided in half. Such a configuration may be employed.

As illustrated in FIG. 19 by way of example, the magnet holding portion 70 is formed separately from the tubular body portion 72 of the outer peripheral iron core portion 46. The permanent magnet 49 includes the divided magnets 130 divided in half in the circumferential direction at the q-axis. The partition portion 132 of the magnet holding portion 70 extends in the radial direction to pass between the divided magnets 130 divided in half. Such a configuration may be employed.

As illustrated in FIG. 20 by way of example, the magnet holding portion 70 is formed separately from the tubular body portion 72 of the outer peripheral iron core portion 46. The permanent magnet 49 includes the divided magnets 130 divided into three magnets in the circumferential direction at the q-axis. Two partition portions 132 of the magnet holding portion 70 are, corresponding to the divided magnets 130 divided into three magnets, provided next to each other in the circumferential direction. Moreover, the partition portion 132 extends in the radial direction to pass between each two adjacent divided magnets 130. Such a configuration may be employed.

In the above-described variation, the divided magnet 130 is arranged and sandwiched between the side surface holding portion 74 and the partition portion 132 or between the partition portions 132. With this configuration, the permanent magnet 49 can be held between the claw-shaped magnetic pole portions 44 in this variation. Moreover, the q-axis magnetic circuit magnetically isolated from a d-axis magnetic circuit can be formed on the q-axis by means of the magnet holding portion 70 (particularly the partition portion 132 and the annular portion 134), and therefore, the reluctance torque is generated to improve the torque in the present variation.

Further in the above-described variation, the annular portion 134 of the magnet holding portion 70 has such a double structure that a space 140 is formed as illustrated in FIG. 17 by way of example. Moreover, in the present variation, a permanent magnet 142 is arranged in the space 140 on the inside of the annular portion 134 arranged on the inside of the claw-shaped magnetic pole portion 44 in the radial direction. The permanent magnet 142 is held together with the claw-shaped magnetic pole portion 44 by the magnet holding portion 70. The permanent magnet 142 is configured such that a permanent magnet orientation direction is deviated to the side of the rotor 20 in the radial direction. Thus, the permanent magnet 142 more efficiently outputs magnetic force as compared to the divided magnet 130. In the divided magnet 130, a magnetic flux direction is toward the d-axis center of the claw-shaped magnetic pole portion 44. A magnetic flux is branched into a magnetic path toward the annular portion 134 gripping the magnetic with high magnetic resistance and a magnetic path toward the stator iron core 60 with lower magnetic resistance than that described above. Thus, the magnetic flux flows in the stator iron core 60 while a magnetic flux direction of the permanent magnet 142 is also directed to the stator iron core 60. Consequently, action similar to that of the divided magnet 130 is generated by a smaller number of magnets than the divided magnets 130.

The technique of the present disclosure is not limited to the above-described embodiment and variations. Various changes can be made without departing from the gist of the present disclosure.

### REFERENCE SIGNS LIST

20 . . . rotating electrical machine rotor
22 . . . rotating electrical machine
24 . . . stator
40 . . . boss portion
42 . . . disc portion
44 . . . claw-shaped magnetic pole portion
44-1 . . . first claw-shaped magnetic pole portion
44-2 . . . second claw-shaped magnetic pole portion
46 . . . outer peripheral iron core portion
46-1 . . . first divided iron core portion
46-2 . . . second divided iron core portion
48 . . . field winding
49 . . . permanent magnet
49a . . . first permanent magnet
49b . . . second permanent magnet
50 . . . rotary shaft
54 . . . clearance space
54a . . . first clearance space
54b . . . second clearance space
56 . . . thin plate member
58n . . . side surface (N-pole side)
58s . . . side surface (S-pole side)
70, 110 . . . magnet holding portion
70a . . . first magnet holding portion
70b . . . second magnet holding portion
72 . . . tubular body portion
74a-1, 74a-2, 74b-1, 74b-2, 112 . . . side surface holding portion
76a-1, 76a-2, 76b-1, 76b-2 . . . axial end surface holding portion
78w, 78e . . . axial end surface
100 . . . linear member
102 . . . band-shaped member
120 . . . internal space
122 . . . predetermined space
124 . . . tapered portion
130 . . . divided magnet

1. A rotating electrical machine rotor comprising:
multiple magnetic pole portions facing a stator in a radial direction, arranged with clearance spaces therebetween in a circumferential direction, and alternately magnetized to different polarities in the circumferential direction by power application to a field winding;
permanent magnets arranged in each clearance space such that a polarity of each of side surfaces facing the magnetic pole portions in the circumferential direction is the same as a polarity of a corresponding one of the magnetic pole portions; and a tubular outer peripheral iron core portion configured to cover an outer peripheral side of the magnetic pole portions, wherein
the outer peripheral iron core portion has a tubular body portion and magnet holding portions configured to hold the permanent magnet.

2. The rotating electrical machine rotor according to claim 1, wherein
the magnet holding portion is formed to protrude from an inner peripheral surface of the tubular body portion toward a radial inside while gripping the permanent magnet.

3. The rotating electrical machine rotor according to claim 1, wherein
the outer peripheral iron core portion has a structure in which soft magnetic thin plate members are stacked on each other in an axial direction or a structure in which a soft magnetic linear member or a band-shaped member is spirally stacked in the axial direction, and
the outer peripheral iron core portion is integrated such that the thin plate members or stacked portions of the linear member or the band-shaped member are bonded along the axial direction using the magnet holding portion.

4. The rotating electrical machine rotor according to claim 1, wherein
the tubular body portion and the magnet holding portion are formed from different components.

5. The rotating electrical machine rotor according to claim 1, wherein
the magnet holding portion has a side surface holding portion facing a corresponding surface of the permanent magnet and extending along the axial direction.

6. The rotating electrical machine rotor according to claim 5, wherein
the magnetic pole portions include first and second magnetic pole portions formed such that a circumferential width changes from a base side in the axial direction to a tip end side in the axial direction, alternately arranged in the circumferential direction such that a position of the base side in the axial direction and a position of the tip end side in the axial direction are on opposite sides in the axial direction, and magnetized to different polarities,
the clearance spaces include first and second clearance spaces inclined from a first side to a second side in the axial direction at a predetermined angle with respect to a rotation axis and provided in different skew directions inclined with respect to the rotation axis,
the outer peripheral iron core portion has a structure in which cylindrical first and second divided iron core portions divided in half in the axial direction are bonded at a center position in the axial direction,
the first divided iron core portion has the side surface holding portion for holding a first permanent magnet arranged in the first clearance space, and
the second divided iron core portion has the side surface holding portion for holding a second permanent magnet arranged in the second clearance space.

7. The rotating electrical machine rotor according to claim 6, wherein
the first divided iron core portion is formed such that the side surface holding portion holds the permanent magnet in a state in which the first divided iron core portion is inserted onto each magnetic pole portion while rotating in a first spiral direction corresponding to the skew direction of the first clearance space, and
the second divided iron core portion is formed such that the side surface holding portion holds the permanent magnet in a state in which the second divided iron core portion is inserted onto each magnetic pole portion while rotating in a second spiral direction corresponding to the skew direction of the second clearance space.

8. The rotating electrical machine rotor according to claim 1, wherein
the magnet holding portion has an axial end surface holding portion portion facing an axial end surface of the permanent magnet and extending along the circumferential direction.

9. The rotating electrical machine rotor according to claim 1, wherein
the magnet holding portion is formed with a tapered section to divide a space between the permanent magnet and the tubular body portion into an internal space where the permanent magnet is held and a predetermined space formed on an outside of the internal space in the radial direction, and
each magnetic pole portion has a tapered portion arranged to fill the predetermined space.

10. The rotating electrical machine rotor according to claim 1, wherein
the permanent magnet is divided into two or more magnets in the circumferential direction at a q-axis at a position shifted from a d-axis passing through a center of each magnetic pole portion in the circumferential direction by an electrical angle of 90°, and
the magnet holding portion is formed to hold the permanent magnet, surround each magnetic pole portion, and have an iron core portion at which a q-axis magnetic circuit passing through the q-axis is formed.
